(19) United States
(12) Patent Application Publication
(10) Pub. No.: US 2025/0348845 A1
(43) Pub. Date: Nov. 13, 2025

(54) METHODS FOR ON-DEMAND SHOWING OF A REAL ESTATE PROPERTY

(71) Applicant: Afshin Ghezelayagh Ghazi, Charlotte, NC (US)

(72) Inventor: Afshin Ghezelayagh Ghazi, Charlotte, NC (US)

(21) Appl. No.: 18/657,984

(22) Filed: May 8, 2024

(51) Int. Cl. G06Q 10/109; G06F 40/174; G06Q 30/0282; G06Q 50/16

(52) U.S. Cl. CPC G06Q 10/109; G06F 40/174; G06Q 30/0282; G06Q 50/16

(57) ABSTRACT

A method for providing on-demand access to a real estate property including a step of (a) providing a computer system with real estate property data and data for property access facilitators, such as those local to the property; (b) operating the computer system to provide an interested party with an on-demand access to the data related to the property, (c) operating the computer system to accept a request from the interested party to arrange on-demand access to the property, (d) operating the computer system to contact property access facilitators with an invitation to provide on-demand access to the property, and (e) upon receiving acceptance of at least one respondent property access facilitator, operate the computer system to notify the interested party of the upcoming access to the property to be provided by a selected property access facilitator that is available to conduct a showing of the property.

### BACKGROUND

Without limiting the scope of the invention, its background is described in connection with methods for gaining access to and evaluating real estate properties by a prospective interested party. More particularly, the invention describes streamlined methods for gaining rapid access to the real estate property of interest without having to go through a long series of steps associated with conventional methods of evaluating real estate properties.

A conventional process of gaining access to a real estate property as a prospective buyer typically involves several detailed steps, beginning with preliminary research and culminating in a physical tour of the property. Initially, the buyer often conducts online research to identify potential properties that fit their criteria, such as location, size, price, and amenities. This phase may include browsing real estate websites, contacting real estate agents, or utilizing social media and networking to find available listings. Once a prospective property is identified, the buyer usually contacts a real estate agent or the seller directly to express interest and request more information. The agent or seller provides details about the property, including its features, history, and any pertinent disclosures that may affect the buyer's decision. During this interaction, the buyer may also discuss their financial qualifications, which helps the agent or seller assess the buyer's seriousness and ability to proceed with a potential purchase.

Following the initial discussions, if the buyer remains interested, they schedule a visit to the property. This scheduling process involves coordinating with the seller or the seller's agent to find a mutually convenient time. In many cases, the seller's agent will be present during the visit to provide access to the property, guide the tour, answer questions, and discuss the property's aspects in detail.

During the property visit, the prospective buyer has the opportunity to inspect the property thoroughly, checking the condition of various elements such as the structure, plumbing, electrical systems, and appliances. This visit allows the buyer to visualize living or working in the space, assess its suitability for their needs, and identify any potential issues that might require further negotiation or inspection. If the buyer decides to move forward after the visit, the next steps would involve making an offer, conducting formal inspections, and proceeding with the purchase process, which includes negotiations, securing financing, and closing the deal. However, gaining initial access to the property for a viewing is a crucial step in the buying process, as it provides the prospective buyer with a tangible sense of the property's condition and value.

This highly structured process involves the coordination of efforts of many people, including the property owner, the listing agent, the prospective buyer, or another interested party, as well as the buyer's real estate agent. As a result, real estate property may only be viewed by appointment only as scheduled well in advance of the date of the showing.

One of the limitations of this traditional approach is that it does not allow for an instant, on-demand property showing. For example, if a buyer drives through the neighborhood that the buyer is interested in and comes across a house with a “For Sale” sign in front of it, there is no practical way for the buyer to enter the house for inspection without making an appointment, typically with the listing agent or the property owner, for some future day.

Once a property catches the buyer's attention as a result of a drive-by, for example, the next step is to reach out to the listing agent or the property owner, if it is a private sale, to express interest and request a showing. This outreach is typically done via phone, email, or through a real estate web-based platform that facilitates communication between buyers and sellers.

Next, the listing agent or seller checks the property's availability and consults with the seller to determine suitable times for the showing. They then propose potential dates and times to the buyer's agent, who coordinates with the buyer to finalize a time that works for all parties involved. This coordination often involves balancing the schedules of the buyer, the buyer's agent, the seller, and the seller's agent requiring flexibility and communication to ensure the appointment is convenient for everyone. Once a showing time is agreed upon, the listing agent or seller confirms the appointment and provides any necessary details, such as the property address, directions, and any special instructions for accessing the property. For instance, there might be security measures, gate codes, or specific parking instructions to follow. On the day of the showing, the buyer and their agent typically meet at the property. The listing agent or seller's representative is often present to unlock the property, provide a tour, highlight key features, answer questions, and discuss the property's history and condition.

The need exists, therefore, to improve and streamline this cumbersome process so that access to a real estate property of interest may be gained instantly or on-demand, such as when the prospective buyer first encounters the property and is interested in learning more about it. The ability to enter the property without a need to come back another day may greatly improve the process of conducting a real estate transaction for both buyers and sellers.

The same ability to inspect a real estate property of interest on-demand may be beneficial in other types of real estate transactions, such as renting, selling commercial real estate, gaining access to a vacation property of interest, etc., as all of these real estate transactions suffer from the same inefficiency and delays in showing the property itself to the interested party.

### SUMMARY

Accordingly, it is an object of the present invention to overcome these and other drawbacks of the prior art by describing a novel method for providing on-demand or immediate access to the real estate property to an interested party while at the location of the property and without having to come back at a later day.

It is another object of the present invention to provide a novel method for an interested party to access a property of interest without the need to contact the listing agent or the property owner and without the need to have the listing agent or the property owner be present on site.

It is a further object of the present invention to provide a novel method of streamlining the process of marketing and showing of a real estate property to attract as many visitors and prospective buyers as possible including an interested party that happened to be in close proximity thereto.

It is yet a further object of the present invention to provide a novel method of automating the process of providing access to a real estate property which results in immediate availability of showing the property to an interested party.

One method for providing on-demand access to a real estate property to an interested party, according to the present invention, may include the following steps:
providing a computer system containing or having access to data related to the real estate property. The computer system may also contain or have access to a database of a plurality of property access facilitators, such as those that are local to the property and can travel thereto within a short period of time;
operating the computer system to provide the interested party with on-demand access to at least some of the data related to the real estate property,
operating the computer system to accept a request from the interested party to arrange on-demand access to the real estate property, wherein the request may be transmitted electronically via a variety of common methods;
operating the computer system to contact at least one or more property access facilitators with an invitation to provide the interested party with on-demand access to the real estate property, and
upon receiving acceptance of at least one respondent property access facilitator, operate the computer system to notify the interested party of the upcoming access to the real estate property to be provided by a selected property access facilitator that is available to provide the access and conduct a showing of the property.

In further steps, the computer system may be configured to interact with the interested party and other participants of the showing of the real estate property via a variety of electronic communications methods, including one-or two-way communication via a website user interface, an entry of a uniform resource locator (URL), an email interaction, a smartphone application interface, a barcode interaction, a text messaging interaction, and a telephone call.

Additionally, the computer system may be operated to detect the times when the showing of the real estate property starts and ends, as well as at least one of a video- or audio recording of a part of or the entire showing. This may be done using at least one or more of the microphones and/or video cameras located at the real estate property or brought there by the property access facilitator.

The method may further include a step of operating the computer system to automatically initiate a follow-up communication with the interested party once a showing of the real estate property is complete, for example with a request to rate the real estate property, a contract for a transaction for the interested property with regard to the real estate property, or another suitable content.

Another method for providing on-demand access to a real estate property to an interested party that may be already waiting at the location of the property, according to the present invention, may include the following steps:
providing a computer system containing or having access to data related to the real estate property, wherein the computer system also contains or has access to a database of a plurality of local property access facilitators;
in response to receiving a request for access to the real estate property from the interested party, operating the computer system to contact at least one local property access facilitator with an invitation to proceed to the real estate property to provide upon arrival access thereto to the interested party; and
upon receiving an acceptance from at least one of the local property access facilitators, operating the computer system to:
   designating a selected local property access facilitator for providing access to the real estate property to the interested party, and
   notify the interested party of the time of arrival of the selected property access facilitator to provide access thereto for the interested party,
wherein if the real estate property is available at the time of receiving the request for access in step (c), access to the real estate property is provided to the interested party while awaiting at the location thereof.

Yet a further method for providing access to enter a real estate property to an interested party, according to the invention, may include the following steps:
providing a computer system containing or having access to data related to the real estate property, wherein the computer system also contains or has access to a database of a plurality of local property access facilitators;
in response to receiving a request for access to the real estate property from the interested party, operating the computer system to contact at least one local property access facilitator with an invitation to proceed immediately or at a scheduled time to the real estate property to provide upon arrival access thereto to the interested party; and
upon receiving at least one acceptance from local property access facilitators, operating the computer system to:
designate a selected property access facilitator from all respondent property access facilitators for providing access to the real estate property to the interested party, and
notify the interested party of the time of arrival of the selected property access facilitator to provide immediate or scheduled access thereto for the interested party.

### BRIEF DESCRIPTION OF THE DRAWINGS

Subject matter is particularly pointed out and distinctly claimed in the concluding portion of the specification. The foregoing and other features of the present disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 is a general view of communications between various parties and components of the computer system of the present invention.

### DETAILED DESCRIPTION OF PREFERRED EMBODIMENTS OF THE INVENTION

The following description sets forth various examples along with specific details to provide a thorough understanding of the claimed subject matter. It will be understood by those skilled in the art, however, that claimed subject matter may be practiced without one or more of the specific details disclosed herein. Further, in some circumstances, well-known methods, procedures, systems, components, and/or circuits have not been described in detail in order to avoid unnecessarily obscuring the claimed subject matter. In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and make part of this disclosure.

The term “real estate property” is used herein to broadly describe a defined piece of land and/or a place of residence or a commercial establishment located thereon. Examples of various types of real estate property include a house or a part thereof, an apartment, a store, a commercial building, an office space, a vacation house, a parcel of land, a parking lot, or any other known a defined locations and/or properties that may be sold, rented, leased, mortgaged, exchanged, or otherwise be a subject of a real estate contract.

The term “interested party” may include one or more persons who may be interested in accessing the real estate property. Examples of such an interested party include a buyer, a real estate agent, a banker, an attorney, a contractor, or anyone else that needs to enter the property that may be locked or otherwise require a prior arrangement for entry therein.

The term “computer system” is used herein to broadly describe a system comprising one or more computer servers configured to operate together to execute a program that embodies the steps of the methods of the present invention described herein. The computer system may operate on one or more local or remotely located computers or servers, which may be configured to communicate between themselves and with the participants of the method steps via a variety of communication methods and protocols. Examples of such communication methods include wired and wireless communication via the internet, via at least one of a website user interface, an entry of a uniform resource locator (URL), an email interaction, a smartphone application interface, a barcode interaction, a text messaging interaction, and a telephone call. In embodiments, at least some of the steps may be implemented automatically, for example, using automated voice recognition methods. In other embodiments, at least some of the steps may be assisted by an operator or manually by other methods, for example, in responding to an inquiry from an interested party, or in arranging for a meeting at the location of the real estate property.

The computer system may also include or be configured to interact with a variety of remote electronic devices, such as cell phones, smartphones, tablets, laptops, smart watches, etc. Such interaction may occur via direct or remote access, such as via the internet or via cellular or WiFi communications including a call, a text, an electronic message, an email, a post on social media, etc., as the invention is not limited in this regard.

Central to the computer system is having access to or incorporating a robust database that stores comprehensive information and data on real estate properties. The database in a real estate computer system can include a wide range of information on each property to facilitate buying, selling, renting, leasing, and management processes. Common categories of information and data may include:
Property Details: Address and Location: Precise location, including street address, city, state, and zip code.
Type of Property: Residential, commercial, industrial, or land.
Property Features: Number of bedrooms, bathrooms, square footage, lot size, and unique features like swimming pools, gardens, or garages.
Financial Information:
   Listing Price: Current asking price for the property.
   Tax Information: Historical property tax data, and current tax rates.
   Transaction History: Previous sale prices and dates of transactions.
Legal Information:
   Ownership Details: Current and previous owners.
   Title Information: Status of the property title, including any liens or encumbrances.
   Zoning Information: Local zoning regulations that apply to the property, including permissible uses.
Condition and Age:
   Year Built: When the property was constructed.
   Condition of Property: Information on the current state of the property, including any recent renovations or issues.
Market Data:
   Comparative Market Analysis (CMA): Data comparing the property to similar properties in the area to estimate its value.
   Trends and Forecasts: Local real estate market trends, including price appreciation or depreciation.
Images and Multimedia:
   Photographs: High-resolution images of the interior and exterior of the property.
   Virtual Tours: 360-degree tours or video walkthroughs of the property.
Energy and Utility Information:
   Utilities: Details about the type of heating, cooling, water, and electricity systems.
   Energy Efficiency Ratings: Information on the property's energy performance, such as insulation quality and renewable energy installations.

The computer system of the present invention may have access to or be integrated with the financial services to enable seamless processing of payments, mortgages, and other financial transactions, ensuring that all financial aspects of real estate transactions are handled securely and efficiently. Additionally, the computer system may be connected to or include legal and governmental databases to automate the verification of property titles, zoning regulations, and compliance with local real estate laws.

The computer system of the present invention may also contain or have access to a database of a plurality of property access facilitators. The term “property access facilitator” is used herein to describe a person within a database who is trained or instructed on how to provide access to real estate property to the interested party. While the database may include a list of licensed real estate agents, it is not limited thereto. The database of property access facilitators may include any other person, such as real estate assistants, or anyone else who is registered to be a part of the database and who complies with local rules and regulations that may vary by state.

At a minimum, the database may include the name and contact information of every property access facilitator. In addition, at least some or all of the records of the database may include address, specific qualifications, licenses, history of showing properties, ratings and reviews by prior customers, and other information pertaining to individual property access facilitators.

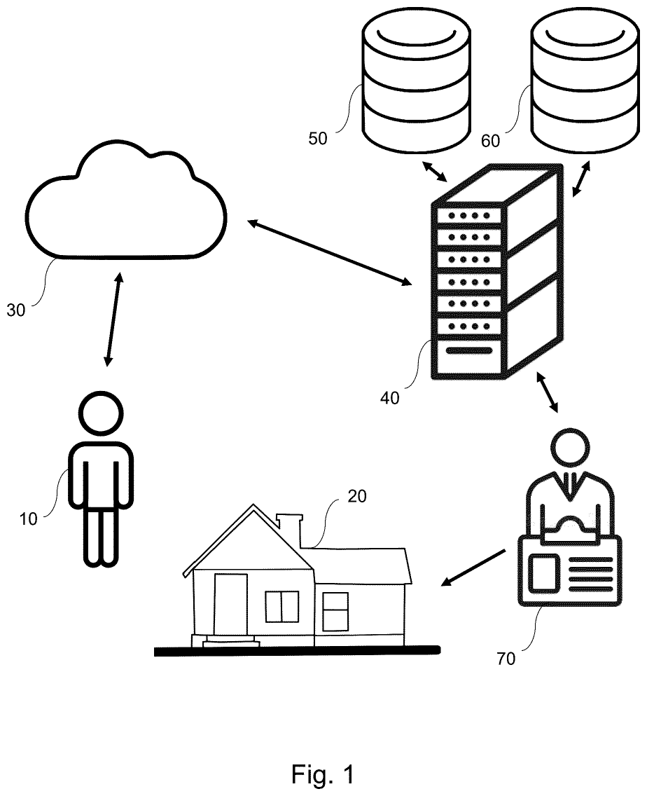

FIG. 1 illustrates communications between key participants and the main components of the computer system of the present invention. Shown in FIG. 1 are the interested party 10 which may be located in the vicinity of the real estate property 20. The interested party 10 may communicate with the computer system 40 via the Internet or via a number of other communication channels as described above. The one or more servers of the computer system 40 may be connected to or internally contain a database 50 with data related to the real estate property 20 as well as other real estate properties that may be of interest to the interested party 10. The computer system 40 may also contain or have access to a database 60 of a plurality of property access facilitators, as described above. Also shown in FIG. 1 is a selected property access facilitator 70, described in greater detail below.

The following is an exemplary discussion of one common scenario when the methods of the present invention may be used to the maximum advantage for all parties involved in a typical real estate transaction, such as buying or renting a house or another residence. As mentioned above, under the current system of looking for a new house, the prospective buyer may not easily enter the property of interest without first going through multiple verification and scheduling steps that may take a while. As a result, both the property owner as well as the prospective buyer lose the opportunity to immediately extend the initial interest that the interested party had while driving by a prospective property. As circumstances change, the interested party may never come back to the real estate property and a chance to complete the transaction is lost.

According to the present invention, when the interested party first identifies a property of interest, such as while driving by or being in the vicinity of the property for some other reason, the interested party has an opportunity to further evaluate the property and gain access thereto right then and there.

A first step of the method may be to provide a computer system 40, as described above, which contains a database 50 or has access to data related to the real estate property 20. Some examples of data providers that the computer system 40 may be connected to access real estate property data may include the following:
MLS (Multiple Listing Service): A collection of services that real estate brokers use to establish contractual offers of compensation and accumulate and disseminate information to enable appraisals.
Zillow: Offers extensive property listings, historical data, and market trend analysis.
Redfin: Provider of real-time real estate data, including listings, sales, and market trends.
Realtor.com: Provides listings, market data, and insights into the real estate market.
CoreLogic: Specializes in property data, analytics, and market insights for real estate professionals.
CoStar Group: Offers comprehensive real estate data, including commercial property information, analytics, and market insights.
PropertyShark: Provides in-depth data on property values, sales history, and ownership information.
LoopNet: Focuses on commercial real estate listings and data, including market trends and property information.
Trulia: Offers real estate listings and data, including detailed information on neighborhoods, schools, and market trends.
Real Capital Analytics: Specializes in commercial real estate data, tracking transactions, and market trends globally.

The computer system 40 may also contain or have access to a database 60 of a plurality of property access facilitators. These individuals may include a diverse group of real estate agents (including the listing agent, as well as other seller and buyer real estate agents, real estate agent assistants, property owner for the property of interest, organizers of open house events for the property (with respective times for these events), representatives of real estate companies that may manage the property, representatives of property management companies, etc.

Importantly, the database of property access facilitators may also include individuals seeking part-time opportunities to make money. These individuals may be registered to act as property access facilitators and verified prior to being listed but may not have much other real estate experience in the past. These individuals may undergo initial training in how to use the computer system 40 and how to provide access to interested parties. Other requirements may need to be fulfilled as well depending on local rules and regulations.

In embodiments, a dedicated property access facilitator smartphone application may be downloaded by every person listed as a property access facilitator. The app may be used for communication with the computer system 40 as described in greater detail below.

A subsequent step of the method may include operating the computer system 40 to provide the interested party 10 with on-demand access to at least a portion of the data related to the real estate property 20. This may be done by having the interested party communicate with the computer system 40 via the Internet or any other communication methods listed above. The step of providing data may be as simple as indicating to the interested party that the real estate property 20 is available for sale or rent and listing some basic facts and information about the property. Further information may be provided such as in the categories listed above.

In other embodiments, the interested party may scan a barcode located, in one example, on the “For Sale” sign in front of the property to gain access to the data describing the property. In further embodiments, interested party 10 may send a message or a social network post to request this information. In other embodiments, this information may be requested by phone or email, as the invention is not limited in this regard.

In further yet embodiments, a dedicated smartphone application may be provided to be installed on the smartphone of the interested party. Once downloaded and installed, the app may be used to provide secure access of the interested party to the features of the app including requesting on-demand access to the property. Registration of the interested party may include a name, address, phone number, and other pertinent information such as a copy of the driver's license that may be usually required by a real estate agency to qualify the interested party as allowed to access real estate properties. The app may be configured to go through the registration and authentication process rapidly and complete the process shortly after installation. This may be advantageous to facilitate on-demand access to a property of interest for a new interested party that has not used the app before.

In further embodiments, the app may be configured to solicit information about the objectives of the interested party so as to offer alternative real estate properties for consideration by the interested party.

A further step of the method may include operating the computer system 40 to accept a request from the interested party 10 to arrange on-demand or scheduled access to the real estate property 20. Such a request may be received via the app or by other communication methods listed above. The request may specify whether access to the property may be required immediately or at a future desired time.

Once the computer system 40 receives and accepts the request, it may be automatically operated to check property availability against a predetermined set of times when the property is available for accessing and showing to an interested party. If no such schedule is available, the computer system 40 may be configured to send an automated message to a designated person, such as the owner or a listing real estate agent, to inquire about the availability of the property. In other embodiments, an agent supporting the operation of the computer system 40 may be used to make a phone call to the designated person to inquire about property availability or to make an appointment for a showing at a future time.

In embodiments, once the property is confirmed as available for showing, the computer system 40 may be configured to contact at least one property access facilitator of the plurality of property access facilitators from the database 60 with an invitation to provide the interested party 10 with on-demand access to the real estate property 20. In embodiments, the computer system 40 may be configured to contact one, several, or all property access facilitators who are considered to be local with respect to the real estate property. The definition of “local” for the purposes of the invention may be based on the predefined maximum distance to the property or a predefined maximum travel time thereto. As to the maximum distance, this threshold may be selected and adjusted if needed when the real estate property is first associated with the computer system 40. The distance may be calculated from the listed or current location of the property access facilitator. The current location may be determined, for example, by using a GPS location of the smartphone of the property access facilitator associated with the downloaded app as described above. The predefined maximum travel time may also be determined using a listed location or a current location of the property access facilitator, as well as a predefined method of transportation, such as traveling by car. The computer system 40 may be further connected to data indicating present traffic and travel conditions so as to estimate the travel time for each property access facilitator that is being considered to be contacted by the computer system 40.

In further embodiments, the computer system 40 may be configured to expand a list of local property access facilitators to be contacted on behalf of the interested party when the access and/or showing of the real estate property 20 is requested to be done at a future scheduled time. In that case, the computer system 40 may be configured to access the request from the interested party and contact a list of potential property access facilitators within a predefined time, such as one hour, in advance of the requested pre-scheduled access time.

In embodiments, initial set-up and/or subsequent adjustments to all predefined thresholds may be done by the property owner or the listing agent at the time when the real estate property 20 is first associated with the computer system 40.

While in some embodiments, the computer system 40 may contact some or all of the local property access facilitators at the same time, in other embodiments, the computer system 40 may contact the property access facilitators in a predefined order or according to a predefined hierarchy. One example of such hierarchy may be as follows:
property owner or an owner-designated party,
listing real estate agent,
other real estate agents from the real estate office of the listing real estate agent,
other local property access facilitators.

Other order-of-contact rules may also be used, as the present invention is not limited in this regard.

In embodiments, some or all property access facilitators may have the option to set the time and date ranges when they are available to provide access to properties requested by interested parties. Availability of property access facilitators may be scheduled or adjusted on demand, for example, when a person has some time available to serve as a property access facilitator. The computer system 40 may maintain a real-time list of available property access facilitators and update the list when new availability information is received.

Once one or more property access facilitators receive the notification inviting them to provide access to a particular real estate property, they have an opportunity to access or reject this request. The computer system 40 may be configured to accept the first submitted positive response from the list of respondent local property access facilitators, designate the property access facilitator as the selected property access facilitator 70 to provide access to the real estate property 20, and notify the interested party of the identity of the selected property access facilitator and, in some embodiments, of the estimated time of arrival of the property access facilitator 70 to the property 20. The computer system 40 may be further configured to send a cancellation notification to other respondent and non-respondent property access facilitators who were contacted previously to inform them that the opportunity to provide access is no longer available. In further embodiments, the computer system 40 may send invitations to provide access to the property in stages according to the selected hierarchy of contact rules. For example, if none of the first group of invitees does not respond within the allowed time window, the computer system 40 may send a second batch of invites and continue to seek a positive response until at least one of the local property access facilitators is interested in proceeding to the real estate property 20.

The computer system 40 may be further configured to respond to the request from the interested party 10 with a message indicating whether the real estate property 20 is available now or at a future time. The computer system 40 may notify the interested party 10 of the future availability of the real estate property 20 in case the on-demand access request conflicts with the predetermined real estate property 20 availability schedule in this case, the interested party 10 may be allowed to make an appointment to access the property 20 on another day.

In case the property is available now, the interested party may be notified of the arrival time of the property access facilitator. While awaiting the arrival of that person, the interested party may be provided with additional information about the property 20 or general information about the neighborhood, schools, shopping, entertainment, and other local information of interest.

While the selected property access facilitator 70 is traveling to the property, the computer system 40 may be configured to provide access instructions including access codes, identity of the interested party 10 awaiting at the property, scheduled appointment time, as well as other information needed for the property access facilitator to provide access to the real estate property 20 to the interested party 10. The computer system 40 may be further configured to update the estimated time of arrival for both the interested party 10 and the property access facilitator 70, for example by updating this information on the respective apps on the smartphones of both parties.

Once both the interested party 10 and the property access facilitator 70 are at the location of the real estate property 20, the computer system 40 may be configured to allow access to the property 20. In embodiments, the computer system 40 may be configured to only allow access to the property 20 when both parties are at the same location and that location corresponds to the location of the property 20. This may be done to avoid providing access to the property 20 to only the property access facilitator unless the interested party is also detected to be at the same location. In other embodiments, access to the property may be provided to the property access facilitator within a predefined time period ahead of time, for example up to 15 minutes ahead of the time of the appointment, so that the property access facilitator may open the property 20 and prepare for the showing thereof to the interested party 10. In other embodiments, the computer system 40 may be further configured to automatically deny access to the real estate property 20 unless both the interested party 10 and the selected property access facilitator 70 are present at the real estate property 20.

Once both parties are detected as being together and at the location of the property 20, the computer system 40 may be configured to detect a start time of the access to the real estate property 20 using a real-time location of the interested party 10 and a real-time location of the respondent property access facilitator being at the location of the real estate property. This may be done for security reasons and to document the entry of both parties to the real estate property 20. While the same information may be detected by monitoring an electronic lock at the property 20, detecting a start time may be advantageous when no electronic lock is present and is available for remote monitoring and granting of access rights.

To further improve safety while at the property 20, the method of the invention may include a step of automated monitoring of the real estate property 20 while the interested party 10 and the selected property access facilitator 70 are present thereat. The monitoring may be provided to detect a sign of distress. The monitoring may be conducted automatically by the computer system 40 or manually by authorized personnel associated therewith. The step of monitoring may be conducted by having access to at least one microphone, at least one video camera, or at least one sensor (such as, for example, an internal motion detection sensor) located at the real estate property 20. In further embodiments, the services of the method performed by the computer system 40 may be accompanied by a service of installing temporary cameras or microphones in one or more locations at the real estate property 20.

If a safety violation or distress is detected as taking place, the computer system 40 may be configured to automatically inform security personnel and/or the local police department, according to acceptable safety rules and regulations specified to the parties involved in advance.

In further embodiments, audio or video monitoring may be provided using the app on the smartphone of the selected property access facilitator 70. In one such example, once both parties are at the property 20, the app may be configured to automatically turn on one or both of the microphone and/or video camera on the smartphone of the selected property access facilitator 70 to record at least a portion of or the entire visit to the property 20 for the duration of the visit. The audio or video recording may be streamed to a remote server and recorded to be available at a later time. The property access facilitator 70 may be instructed to hold the phone in such a manner that this recording may be best conducted without obstruction or interference.

The app on the smartphone of the interested party 10 may be configured to receive a message informing the interested party 10 of such recording and seeking approval therefore in case this is required by local rules and regulations.

At the completion of the showing, the computer system 40 may be configured to detect the end time of the visit by both parties, stop the audio-or video recording, and automatically initiate a follow-up communication with the interested party 10. In embodiments, the follow-up communication may include an invitation to rate the real estate property 20, rate the property access facilitator 70, or provide other comments. This may be done via the messaging within the app on the smartphone of the interested party, by email, messaging, or another communication method, as the present invention is not limited in this regard. In further embodiments, the computer system 40 may be further configured to offer at least one more real estate property for consideration by the interested party 10, such as based on received feedback as described above.

In further embodiments, the computer system 40 may be further configured to facilitate a transaction by the interested party with respect to the real estate property 20, such as providing a set of documents or a contract, including a prefilled contract for sale or lease of the property 20 or facilitate generating other suitable property-specific documents.

In further yet embodiments, the computer system 40 may be further configured to provide offers from local real estate service providers, such as attorneys, bankers, appraisers, insurance providers, title companies, contractors, architects, etc. Upon expression of interest by the interested party, the computer system 40 may automatically notify selected service providers and connect them to the interested party, thereby providing a smooth and expedited experience in conducting a real estate transaction.

While methods of the invention may be most advantageous to provide on-demand access to the real estate property while the interested party is already present at its location (such as may be the case when the interested buyer encounters a house of interest while driving through the neighborhood), the invention is not limited in this regard. The methods of the invention may be used for pre-scheduled access to the property of interest or in other circumstances.

Furthermore, the computer system 40 of the present invention may be configured to facilitate scheduling a series of access appointments to the interested party for properties located nearby. This mode of operation may be beneficial for out-of-town visitors interested in seeing multiple properties on the same day. In this case, the computer system 40 may be configured to initiate contacting one or more property access facilitators at a predefined time ahead of each scheduled appointment or to offer more than one real estate property to provide access to for some or for each of the contacted property access facilitators, depending on the set rules and hierarchy of contacts.

It is contemplated that any embodiment discussed in this specification can be implemented with respect to any method of the invention, and vice versa. It will be also understood that particular embodiments described herein are shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific procedures described herein. Such equivalents are considered to be within the scope of this invention and are covered by the claims.

All publications and patent applications mentioned in the specification are indicative of the level of skill of those skilled in the art to which this invention pertains. All publications and patent applications are herein incorporated by reference to the same extent as if each individual publication or patent application was specifically and individually indicated to be incorporated by reference. Incorporation by reference is limited such that no subject matter is incorporated that is contrary to the explicit disclosure herein, no claims included in the documents are incorporated by reference herein, and any definitions provided in the documents are not incorporated by reference herein unless expressly included herein.

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps. In embodiments of any of the compositions and methods provided herein, “comprising” may be replaced with “consisting essentially of” or “consisting of”. As used herein, the phrase “consisting essentially of” requires the specified integer(s) or steps as well as those that do not materially affect the character or function of the claimed invention. As used herein, the term “consisting” is used to indicate the presence of the recited integer (e.g., a feature, an element, a characteristic, a property, a method/process step or a limitation) or group of integers (e.g., feature(s), element(s), characteristic(s), propertie(s), method/process steps or limitation(s)) only.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AB, BBC, AAABCCCC, CBBAAA, CABABB, and so forth. The skilled artisan will understand that typically there is no limit on the number of items or terms in any combination, unless otherwise apparent from the context.

As used herein, words of approximation such as, without limitation, “about”, “substantial” or “substantially” refers to a condition that when so modified is understood to not necessarily be absolute or perfect but would be considered close enough to those of ordinary skill in the art to warrant designating the condition as being present. The extent to which the description may vary will depend on how great a change can be instituted and still have one of ordinary skilled in the art recognize the modified feature as still having the required characteristics and capabilities of the unmodified feature. In general, but subject to the preceding discussion, a numerical value herein that is modified by a word of approximation such as “about” may vary from the stated value by at least ±1, 2, 3, 4, 5, 6, 7, 10, 12, 15, 20 or 25%.

All of the devices and/or methods disclosed and claimed herein can be made and executed without undue experimentation in light of the present disclosure. While the devices and methods of this invention have been described in terms of preferred embodiments, it will be apparent to those of skill in the art that variations may be applied to the devices and/or methods and in the steps or in the sequence of steps of the method described herein without departing from the concept, spirit and scope of the invention. All such similar substitutes and modifications apparent to those skilled in the art are deemed to be within the spirit, scope and concept of the invention as defined by the appended claims.

What is claimed is:

1. A method for providing on-demand access to a real estate property to an interested party, the method comprising the following steps:
a. providing a computer system containing or having access to data related to the real estate property, wherein the computer system also contains or has access to a database of a plurality of property access facilitators,
b. operating the computer system to provide the interested party with an on-demand access to at least a portion of the data related to the real estate property,
c. operating the computer system to accept a request from the interested party to arrange on-demand access to the real estate property,
d. operating the computer system to contact at least one property access facilitator of the plurality of property access facilitators with an invitation to provide the interested party with on-demand access to the real estate property, and
e. upon receiving acceptance of at least one respondent property access facilitator, operate the computer system to notify the interested party of the upcoming access to the real estate property to be provided by a selected property access facilitator.

2. The method for providing on-demand access to the real estate property, as in claim 1, wherein in step (d) the computer system is operated to contact at least one property access facilitator of the plurality of property access facilitators who are local with respect to the real estate property and are located within a predefined maximum distance therefrom, a predefined maximum travel time thereto, or a maximum predefined time for being available to provide access to the real estate property.

3. The method for providing on-demand access to the real estate property, as in claim 2, wherein step (d) further comprises a step of contacting more than one local property access facilitators if available, and wherein in step (e) the computer system is configured after selecting the respondent property access facilitator to send a cancellation notification to other property access facilitators who were contacted previously in step (d).

4. The method for providing on-demand access to the real estate property, as in claim 1, wherein the computer system is configured to interact with the interested party via at least one of a website user interface, an entry of a uniform resource locator (URL), an email interaction, a smartphone application interface, a barcode interaction, a text messaging interaction, and a telephone call.

5. The method for providing on-demand access to the real estate property, as in claim 1, further comprising a step of detecting a start time of the access to the real estate property using a real-time location of the interested party and a real-time location of the selected property access facilitator being at the location of the real estate property.

6. The method for providing on-demand access to the real estate property, as in claim 5, wherein the computer system is further configured to automatically deny access to the real estate property unless both the interested party and the selected property access facilitator are present at the real estate property.

7. The method for providing on-demand access to the real estate property, as in claim 5, further comprising a step of monitoring the real estate property while the interested party and the selected property access facilitator are present at the real estate property for a sign of distress, wherein the step of monitoring is conducted automatically the computer system or manually by authorized personnel having access to at least one microphone, at least one video camera, or at least one sensor located at the real estate property or associated with the selected property access facilitator.

8. The method for providing on-demand access to the real estate property, as in claim 1, further comprising a step of creating an audio recording and/or a video recording of the interested party over at least a portion of the time while at the real estate property.

9. The method for providing on-demand access to the real estate property, as in claim 8, wherein the audio recording and/or a video recording is created using at least one microphone or at least one video camera located inside the real estate property.

10. The method for providing on-demand access to the real estate property, as in claim 8, wherein the audio recording and/or a video recording is created using at least one microphone or at least one video camera associated with a smartphone of the selected property access facilitator.

11. The method for providing on-demand access to the real estate property, as in claim 1, wherein step (c) further comprises a step of checking the received request from the interested party against a predetermined real estate property availability schedule.

12. The method for providing on-demand access to the real estate property, as in claim 11, wherein the step (c) further comprises a step of notifying the interested party of future availability of the real estate property in case the on-demand access request conflicts with the predetermined real estate property availability schedule.

13. The method for providing on-demand access to the real estate property, as in claim 11, wherein step (c) further comprises a step of accepting a request from the interested party for access to the real estate property at a future time based on the predetermined real estate property availability schedule.

14. The method for providing on-demand access to the real estate property, as in claim 13, wherein steps (d) and (e) are conducted within a predefined time ahead of the future time of the access to the real estate property scheduled in step (c).

15. The method for providing on-demand access to the real estate property, as in claim 1, wherein step (c) further comprises a step of authentication of the interested party prior to accepting the request to provide access to the real estate property.

16. The method for providing on-demand access to the real estate property, as in claim 1, further comprising a step of operating the computer system to automatically initiate a follow-up communication with the interested party once a showing of the real estate property is complete.

17. The method for providing on-demand access to the real estate property, as in claim 16, wherein the follow-up communication comprises an invitation to rate the real estate property, wherein upon completion of a rating by the interested party, the computer system is further configured to offer at least one more real estate property for consideration by the interested party.

18. The method for providing on-demand access to the real estate property, as in claim 16, wherein the follow-up communication comprises a contract for a transaction for the interested party with regard to the real estate property.

19. The method for providing on-demand access to the real estate property, as in claim 18, wherein the computer system is further configured to prefill the contract for the transaction with information specific to the real estate property and to the interested party.

20. The method for providing on-demand access to the real estate property, as in claim 18, wherein the follow-up communication further comprises a list of available real estate service providers to facilitate a transaction of the interested party with regard to the real estate property.

21. The method for providing on-demand access to the real estate property, as in claim 1, wherein the step (e) further comprises a step of operating the computer system to automatically transmit access instructions needed to enter the real estate property to the selected property access facilitator prior to or at a time of arrival thereto.

22. The method for providing on-demand access to the real estate property, as in claim 1, wherein in step (d), the step of operating the computer system to contact at least one property access facilitator is conducted based on a predefined hierarchy of contact priorities.

23. A method for providing on-demand access to enter a real estate property to an interested party awaiting at a location of the real estate property, the method comprising the following steps:
a. providing a computer system containing or having access to data related to the real estate property, wherein the computer system also contains or has access to a database of a plurality of local property access facilitators,
b. in response to receiving a request for access to the real estate property from the interested party, operating the computer system to contact at least one local property access facilitator with an invitation to proceed to the real estate property to provide upon arrival access thereto to the interested party, and
c. upon receiving an acceptance from at least one of the local property access facilitators, operating the computer system to:
i. designating a selected local property access facilitator for providing access to the real estate property to the interested party, and
ii. notify the interested party of the time of arrival of the selected property access facilitator to provide access thereto for the interested party,
wherein if the real estate property is available at the time of receiving the request for access in step (c), access to the real estate property is provided to the interested party while awaiting at the location thereof.

24. A method for providing access to enter a real estate property to an interested party, the method comprising the following steps:
a. providing a computer system containing or having access to data related to the real estate property, wherein the computer system also contains or has access to a database of a plurality of local property access facilitators,
b. in response to receiving a request for access to the real estate property from the interested party, operating the computer system to contact at least one local property access facilitator with an invitation to proceed immediately or at a scheduled time to the real estate property to provide upon arrival access thereto to the interested party, and
c. upon receiving at least one acceptance from local property access facilitators, operating the computer system to:
i. designate a selected property access facilitator from all respondent property access facilitators for providing access to the real estate property to the interested party, and
ii. notify the interested party of the time of arrival of the selected property access facilitator to provide immediate or scheduled access thereto for the interested party.
